(19) United States
(12) Patent Application Publication
(10) Pub. No.: US 2025/0314748 A1
(43) Pub. Date: Oct. 9, 2025

(54) LIDAR WITH INCLINED SCANNING MIRROR STRUCTURE

(71) Applicant: AUTOL CO., LTD, Gyeonggi-do (KR)

(72) Inventors: Eun Sang LEE, Gyeonggi-do (KR); Sang Gyu PARK, Gyeonggi-do (KR); Yong Sung LEE, Gyeonggi-do (KR); Woo Il LEE, Gyeonggi-do (KR)

(73) Assignee: AUTOL CO., LTD, Gyeonggi-do (KR)

(21) Appl. No.: 18/711,832

(22) PCT Filed: Sep. 6, 2022
(86) PCT No.: PCT/KR2022/013354

§ 371 Date: Nov. 8, 2024

(30) Foreign Application Priority Data
Nov. 23, 2021 (KR) 10-2021-0162377

(51) Int. Cl. G01S 7/481

(52) U.S. Cl. CPC G01S 7/4817

(57) ABSTRACT

Provided is a light detection and ranging (LIDAR) having an inclined scanning mirror structure that achieves a wide angle of view, while using one pair of inclined mirrors to thus reduce the number of parts, weight, and size thereof. The LIDAR includes: one pair of mirrors each including a light transmitting part and a light receiving part, the light transmitting part reflecting and transmitting laser light radiated thereto, and the light receiving part receiving the laser light reflected from an object after the light transmission; and a mirror installation member rotated with the one pair of mirrors installed thereon, facing each other at an angle of 180 degrees, wherein the one pair of mirrors is inclined at set angles different in an up-down direction.

### CROSS-REFERENCE TO RELATED APPLICATION

This application claims priority to and the benefit of Korean Patent Application No. 10-2021-0162377 filed in the Korean Intellectual Property Office on Nov. 23, 2021, the entire contents of which are incorporated herein by reference.

### BACKGROUND OF THE INVENTION

### (a) Field of the Invention

The present disclosure relates to a light detection and ranging (LIDAR), and more particularly, to a LIDAR having an inclined scanning mirror structure that transmits and receives the laser light by using a mirror.

### (b) Description of the Related Art

In general, a light detection and ranging (LIDAR) may radiate a laser beam to an object and analyze the laser beam reflected from the object and returning thereto to thus measure and detect the distance, direction, speed, or the like of the LIDAR to the object. The LIDAR has been used for a purpose such as weather observation or distance measurement, and has recently been used in technologies for an autonomous vehicle, the weather observation using a satellite, an unmanned robot sensor, a three-dimensional (3D) image modeling and the like.

The LIDAR is a sensor that transmits the laser light and estimates a distance by measuring an arrival time of the laser light that is reflected from the target and returns thereto, and may be classified into a mechanical LIDAR or a fixed LIDAR based on its light transmission method. The mechanical LIDAR may be driven by rotating a part such as a motor when transmitting and receiving the laser light to thus change its location of transmitting and receiving the laser light. The mechanical LIDAR may have a mirror attached to the motor, and may transmit the laser light at the same reflection angle as an incident angle when the laser light is incident on the mirror.

The LIDAR for an autonomous vehicle is required to display at least 16 vertical channels in order to recognize the object in front, have the lowest possible price by considering its mass production, and have the smallest possible sensor size to secure a better design and prevent a lower range due to air resistance.

Here, the vertical channel may also be expressed as a vertical angle of view, and various LIDAR products for autonomous vehicle, basically with 16 to 128 channels, are currently being sold in the market. However, most of the LIDARs with 16 channels or more may have increased vertical angles of view to thus increase parts applied thereto, thereby increasing all its weight, size, and price, which may lower its mass production.

### SUMMARY OF THE INVENTION

The present disclosure attempts to provide a light detection and ranging (LIDAR) having an inclined scanning mirror structure in which the number of parts, weight, and size thereof are reduced by using one mirror and a blocking member. The present disclosure attempts to provide a light detection and ranging (LIDAR) having an inclined scanning mirror structure that achieves a wide angle of view while reducing the number of parts, weight, and size thereof by using one pair of inclined mirrors.

According to an embodiment, provided is a light detection and ranging (LIDAR) having an inclined scanning mirror structure, the LIDAR including: one mirror including a light transmitting part and a light receiving part integrated into it, the light transmitting part reflecting and transmitting laser light radiated thereto, and the light receiving part receiving the laser light reflected from an object after the light transmission; a mirror installation member rotated with the mirror installed thereon; and a blocking member installed at the mirror installation member, and dividing the mirror into the light transmitting part and the light receiving part.

The mirror may be inclined at a set angle in an up-down direction.

The blocking member may be installed vertically relative to the up-down direction at the mirror.

The mirror installation member may be a plate, and the mirror may be installed on one surface of the plate.

At least one of the mirror installation member and the blocking member may have a process part for preventing vibration during its rotation.

According to an embodiment, provided is a light detection and ranging (LIDAR) having an inclined scanning mirror structure, the LIDAR including: one pair of mirrors each including a light transmitting part and a light receiving part, the light transmitting part reflecting and transmitting laser light radiated thereto, and the light receiving part receiving the laser light reflected from an object after the light transmission; and a mirror installation member rotated with the one pair of mirrors installed thereon, facing each other at an angle of 180 degrees, wherein the one pair of mirrors is inclined at set angles different in an up-down direction.

Each of the one pair of mirrors may include the light transmitting part and the light receiving part integrated into it.

The LIDAR may further include a blocking member installed at the mirror installation member, and dividing each of the one pair of mirrors into the light transmitting part and the light receiving part.

The mirror installation member may be a plate, and the one pair of mirrors may be installed on both surfaces of the plate to face each other at an angle of 180 degrees.

At least one of the mirror installation member and the blocking member may have a process part for preventing vibration during its rotation.

As set forth above, according to an embodiment of the present disclosure, it is possible to reduce the number of mirrors or the number of parts, weight, and size of the LIDAR by including the light transmitting part and the light receiving part integrated into one mirror and dividing the light transmitting part and the light receiving part by using the blocking member.

According to an embodiment, it is possible to implement the angle of view in the inclined up-down direction by installing one mirror to be inclined at the set angle in the up-down direction.

According to an embodiment, it also is possible to achieve the wide angle of view while reducing the number of parts, weight, and size of the LIDAR by the one pair of mirrors inclined at the set angles differing in the up-down direction.

### BRIEF DESCRIPTION OF THE DRAWINGS

FIG. 1 is a perspective view of a main part of a light detection and ranging (LIDAR) having an inclined scanning mirror structure according to an embodiment of the present disclosure.

FIG. 2 is a perspective view of a mirror assembly and a drive motor in FIG. 1.

FIG. 3 is a perspective view of the mirror assembly (including a mirror, a mirror installation member, and a blocking member) in FIG. 1 or 2.

FIG. 4 is a side view of the mirror assembly shown in FIG. 3 and shows an inclined state of the mirror.

FIG. 5 is a side view showing a processing point formed on the mirror installation member of FIG. 4.

FIG. 6 is a side view showing a processing point formed in the blocking member of FIG. 4.

FIG. 7 is an operational state view showing that vertical angles of view are respectively formed by one pair of mirrors in FIG. 3.

FIG. 8 is an operational state view showing that a mirror channel is formed by each vertical angle of view of one pair of mirrors in FIG. 7.

FIG. 9 is an operational state view showing that vertical angles of view are respectively formed in a prior art.

FIG. 10 is an operation state view showing that a mirror channel is formed by the vertical angle of view in FIG. 9

### DETAILED DESCRIPTION OF THE EMBODIMENTS

Hereinafter, embodiments of the present disclosure are described in detail with reference to the accompanying drawings for those skilled in the art to which the present disclosure pertains to easily practice the present disclosure. However, the present disclosure may be modified in various different forms, and is not limited to the embodiments provided herein. A portion unrelated to the description is omitted in order to obviously describe the present disclosure, and the same or similar components are denoted by the same reference numeral throughout the specification.

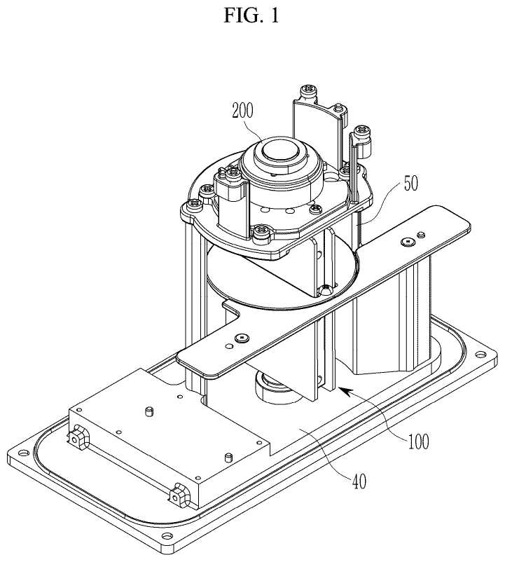

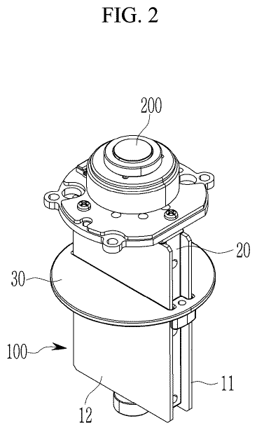

FIG. 1 is a perspective view of a main part of a light detection and ranging (LIDAR) having an inclined scanning mirror structure according to an embodiment of the present disclosure, and FIG. 2 is a perspective view of a mirror assembly and a drive motor in FIG. 1. Referring to FIGS. 1 and 2, the LIDAR in an embodiment may include a mirror assembly 100 and a drive motor 200 driving the mirror assembly 100.

The mirror assembly 100 may include a mirror 12, a mirror installation member 20, and a blocking member 30. The mirror 12 may include a light transmitting part and a light receiving part, the light transmitting part reflecting and transmitting laser light radiated thereto, and the light receiving part receiving the laser light reflected from an object after the light transmission. For example, one mirror 12 may include the light transmitting part and the light receiving part integrated into it.

For example, the mirror installation member 20 may be a plate. The mirror 12 may be installed on the plate. Here, the mirror may be installed on one surface of the plate when one mirror 12 is provided, and the mirrors may be installed on both surfaces of the plate when a pair of first and second mirrors 11 and 12 are provided. In this case, the light transmitting part and the light receiving part may be integrated into each of the pair of first and second mirrors 11 and 12.

The present disclosure may have an optical advantage because the light transmitting part and the light receiving part are integrated into the first mirror 11 on one surface of the plate, and the light transmitting part and the light receiving part are integrated into the second mirror 12 on the other surface of the plate. That is, the present disclosure may require no separate alignment work which is necessary when aligning an optical axis of the light transmitting part and that of the light receiving part, and may minimize an optical error caused by a tolerance occurring while assembling these parts.

Hereinafter, for convenience, the description uses the pair of first and second mirrors 11 and 12 for example. If it is necessary to distinguish the first and second mirrors 11 and 12 from each other, the description is provided by distinguishing a case of one mirror 12 and a case of one pair of the first and second mirrors 11 and 12 from each other. That is, one pair of the first and second mirrors 11 and 12 may be installed on both the surfaces of the mirror installation member 20, which is a plate, and face each other at an angle of 180 degrees.

Referring to FIGS. 1 to 4, the mirror installation member 20 may be rotated to rotate the mirrors 11 and 12 installed thereon. To this end, the drive motor 200 may be connected to one side of the mirror installation member 20. The drive motor 200 may be mounted on a frame 50 installed on a base 40.

That is, an upper rotation shaft 201 and a lower rotation shaft 202 may be provided on both ends of the mirror installation member 20, with the upper and lower rotation shafts 201 and 202 being disposed on the same axis, the drive motor 200 may be connected to the upper rotation shaft 201, and the lower rotation shaft 202 may be rotatably supported by the base 40.

The blocking member 30 may be installed at the mirror installation member 20, and divide each of one pair of the first and second mirrors 11 and 12 into the light transmitting part and the light receiving part. Therefore, the blocking member 30 may block direct reflection light generated when the laser beam transmitted from the light transmitting part is reflected from the light transmitting part to then directly enter the light receiving part.

Therefore, the laser beam transmitted from the light transmitting part may be reflected from the object and received by the light receiving part without the direct reflection light. In addition, the laser beam radiated from a laser light head (not shown) may be transmitted by a reflection action of the light transmitting part, and reflection light reflected from the object may be detected by a sensor (not shown) connected to the light receiving part through a light reception action of the light receiving part.

The LIDAR in an embodiment may use the drive motor 200 to transmit or receive the laser light for each defined horizontal angle of view when the drive motor 200 is rotated. The vertical angle of view (VA) may be determined by a light transmission region where the laser beam is incident on the light transmitting part of the first or second mirror 11 or 12 and reflected back.

For example, in the first or second mirror 11 or 12, the light transmitting part may be set above the blocking member 30 and the light receiving part may be set below the blocking member 30. In addition, the light receiving part may be set to have a greater region than the light transmitting part. Accordingly, the light reflected from the object may be received by the light receiving part to the maximum even though a distance from the laser light head to the light transmitting part is short and in comparison, a distance from the object to the light receiving part is longer.

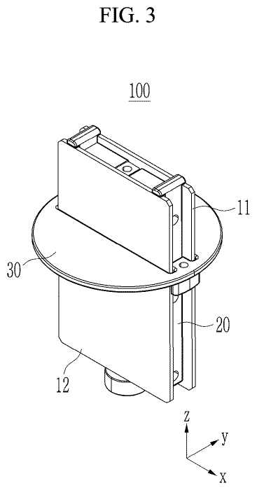

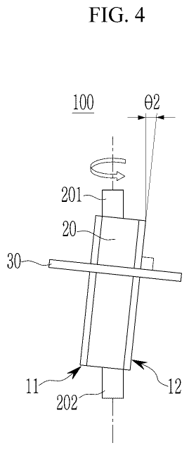

FIG. 3 is a perspective view of the mirror assembly (including the mirror, the mirror installation member, and the blocking member) in FIG. 1 or 2, and FIG. 4 is a side view of the mirror assembly shown in FIG. 3 and shows an inclined state of the mirror.

Referring to FIGS. 3 and 4, the mirror 12 on one surface may be inclined at a set angle θ2 in an up-down direction. For example, the mirror installation member 20 may be a plate, and the first and second mirrors 11 and 12 may be installed on both surfaces of the plate and rotated. In this case, the pair of the first and second mirrors 11 and 12 may have set angles θ1 and 02 that are different from each other.

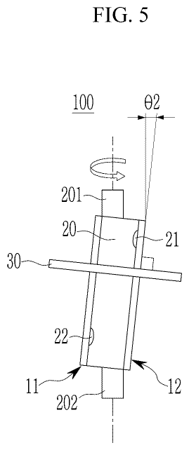

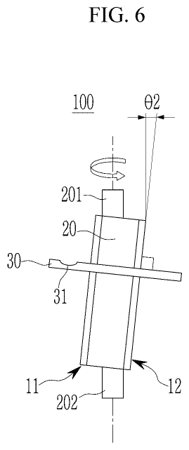

FIG. 5 is a side view showing a processing point formed on the mirror installation member of FIG. 4, and FIG. 6 is a side view showing the processing point formed in the blocking member of FIG. 4. Referring to FIGS. 4 to 6, the blocking member 30 may be installed vertically relative to the up-down direction at the first and second mirrors 11 and 12 and the mirror installation member 20, partitioning the light transmitting part and the light receiving part

The mirror installation member 20 may be inclined at the set angle θ2 and rotated to thus cause vibration. Therefore, the mirror installation member 20 may include process parts 21 and 22 respectively disposed at its upper portion (or the light transmitting part) and lower portion (or the light receiving part) for preventing the vibration. In addition, the blocking member 30 may be rotated integrally with the inclined mirror installation member 20 to thus cause the vibration, and may thus include a process part 31 for preventing the vibration.

The blocking member 30 and the mirror installation member 20 may be rotated integrally with each other, thus requiring to optimize the size and location of each of the process parts 21, 22, and 31. To prevent the vibration, each member may have a weight partially added using a balance weight. However, this embodiment shows that the member weight is partially reduced by including the process parts 21, 22, and 31.

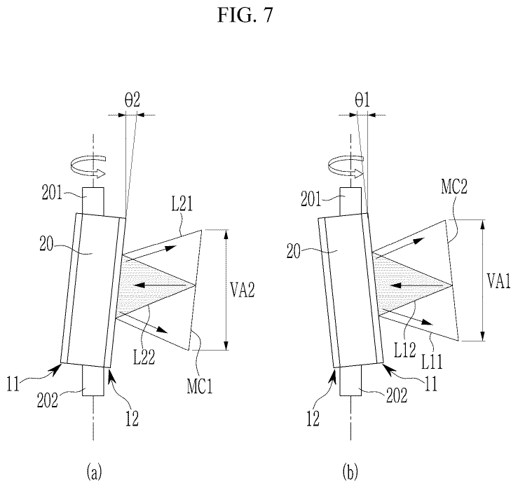

The mirror installation member 20 may be rotated while being inclined, thus having its upper center of gravity and lower center of gravity different from each other. Therefore, when rotated, the drive motor 200 may have its upper center of gravity that is moved to the second mirror 12 on the right, and its lower center of gravity that is moved to the first mirror 11 on the left (see FIGS. 4 to 6). The first mirror 11 may form a vertical angle of view VA1 higher than a center line CL, and the second mirror 12 may form a vertical angle of view VA2 lower than the center line CL (see FIG. 7).

The process parts 21 and 22, allowing the mirror installation member 20 installed with the first and second mirrors 11 and 12 to have different thicknesses, may move the shifted center of gravity to the centers of the rotation axes 201 and 202 of the drive motor 200. That is, the processing point may be disposed in the mirror installation member 20 to thus form the process part 21 by allowing a partial interior of the upper portion that is close to the second mirror 12 to have a smaller thickness, and form the process part 22 by allowing a partial interior of the lower portion that is close to the first mirror 11 to have a smaller thickness. The mirror installation member 20 can achieve balance by means of the process parts 21 and 22 (see FIGS. 4 to 6).

The process part 31 allowing the blocking member 30 to have a different thickness may be used to stabilize the center of gravity of the mirror installation member 20 and the first and second mirrors 11 and 12, which are inclined. That is, the upper and lower centers of gravity may be different from each other, and may not be achieved through the process parts 21 and 22 of the mirror installation member 20. In this case, the center of gravity may be corrected by forming the process part 31 and varying the thickness of the blocking member 30.

A corner of the mirror installation member 20 may be set as a reference point, and its center of gravity may be determined using Equations 1 to 3, based on its distance on each of the three axes (see x-axis, y-axis, and z-axis of FIG. 3) and its weight at a corresponding point. It is possible to determine the overall center of gravity of the mirror installation member 20 by setting its center of gravity based on an ideal mirror installation member 20 having no process part 21 or 22, moving this center of gravity for the center of gravity to be disposed at a desired point (i.e., process part 21 or 22) by a processing work, finally setting the center of gravity by applying the blocking member 30 thereto, and then moving the center of gravity for the center of gravity to be disposed at a desired point (i.e., process part 31) by the processing work.

$${x}_{cm} = \frac{1}{M} {\sum }_{i} {m}_{i} {x}_{i} \qquad ( Equation 1 )$$

$${y}_{cm} = \frac{1}{M} {\sum }_{i} {m}_{i} {y}_{i} \qquad ( Equation 2 )$$

$${z}_{cm} = \frac{1}{M} {\sum }_{i} {m}_{i} {z}_{i} \qquad ( Equation 3 )$$

M indicates a mass of the object, x_{cm} indicates the center of gravity on the x-axis, y_{cm} indicates the center of gravity on the y-axis, z_{cm} indicates the center of gravity on the z-axis, Mᵢ indicates the mass of the object at its location on the x, y, or z-axis, xᵢ indicates the distance of the object at its location on the x-axis, yᵢ indicates the distance of the object at its location on the y-axis, and zᵢ indicates the distance of the object at its location on the z-axis

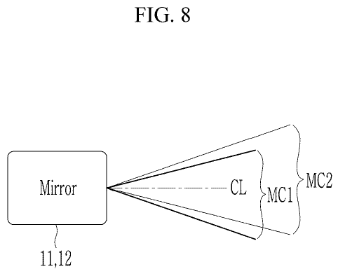

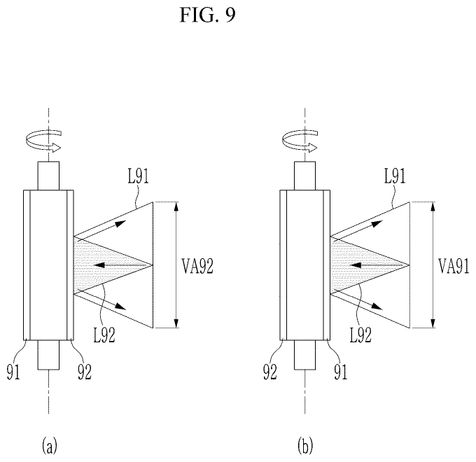

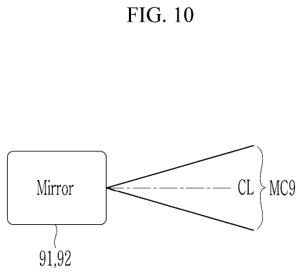

Hereinafter, the description describes an acting effect of the present disclosure with reference to FIGS. 7 and 8, and describes this effect based on its comparison with an acting effect described with reference to FIGS. 9 and 10.

FIG. 7 is an operational state view showing that vertical angles of view are respectively formed by one pair of mirrors in FIG. 3, and FIG. 8 is an operational state view showing that a mirror channel is formed by each vertical angle of view of one pair of mirrors in FIG. 7.

Referring to FIGS. 7 and 8, one pair of first and second mirrors 11 and 12, symmetric to each other, may be inclined at different angles to thus double a scanning resolution, and may form the first and second vertical angles of view VA1 and VA2 to thus increase the vertical angles of view. Here, the first and second vertical angles of view VA1 and VA2 of the first and second mirrors 11 and 12 do not overlap each other.

When each of the first and second mirrors 11 and 12 having the different angles θ1 and θ2 make one rotation, light transmissions L11 and L21 and light receptions L12 and L22 may be respectively performed at the different first and second vertical angles of view VA1 and VA2. The second mirror 12 may form the second vertical angle of view VA2 by using the light transmission L21 lower than the center line CL to thus form a first mirror channel MC1 (see (a) in FIG. 7). The first mirror 11 may form the first vertical angle of view VA1 by using the light transmission L11 higher than the center line CL to thus form a second mirror channel MC2 (see (b) in FIG. 7). Accordingly, the first and second mirrors 11 and 12 having the different angles θ1 and θ2 may scan the second and first mirror channels MC2 and MC1 in regions of the first and second vertical angles of view VA1 and VA2, which are different from each other.

When compared to a case of using the same light transmission and reception circuit or mechanism part, the first and second mirrors 11 and 12 having the different angles θ1 and θ2 may double the scanning resolution (for example, from 16 channels to 32 channels) without adding another light transmission and reception circuit or mechanism part, and increase the vertical angle of view to the first and second vertical angles of view VA1 and VA2.

For example, when the angles θ1 and θ2 are designed to be inclined in increments of 0.08 degrees, a difference between the angles θ1 and θ2 may be 0.16 degrees. The sum of the first and second vertical angles of view VA1 and VA2 of the first and second mirrors 11 and 12 may be 10 degrees, and the total number of channels may be 32. In this case, the LIDAR in this embodiment may achieve a resolution of 0.32 degrees, which is 10/32.

FIG. 9 is an operational state view showing that vertical angles of view are respectively formed in a prior art, and FIG. 10 is an operation state view showing that a mirror channel is formed by the vertical angle of view in FIG. 9. Referring to FIGS. 9 and 10, one pair of mirrors 91 and 92 may be disposed at the same angle without being inclined.

When each of the mirrors 91 and 92 make one rotation, light transmission L91 and light reception L92 may be performed at the same vertical angle of view. The mirrors 91 and 92 may form vertical angles of view VA91 and VA92 by using the light transmission L91 corresponding to the center line CL to thus form a mirror channel MC9.

For example, the sum of the vertical angles of view VA91 and VA92 of the mirrors 91 and 92 may be 10 degrees. In this case, there is no angle difference between the mirrors 91 and 92, and the LIDAR in the prior art may scan the same vertical angles of view VA91 and VA92 twice. The sum of the vertical angles of view VA91 and VA92 is 10 degrees and the total channels are 16, and the LIDAR of the prior art may thus acquire a resolution of 0.6 degrees, which is 10/16. Accordingly, the LIDAR of the prior art may implement each vertical angle of view VA91 or VA92 having a relatively low resolution compared to the resolution of 0.32 in this embodiment.

Although the embodiments of the present disclosure have been described, it is to be understood that the present disclosure is not limited to the disclosed embodiments. Various modifications may be made within the scopes disclosed in the claims, detailed description, and accompanying drawings of the present disclosure, and these modifications also fall within the scope of the present disclosure.

### DESCRIPTION OF SYMBOLS

| | |
|---|---|
| 11: first mirror | 12: second mirror |
| 20: mirror installation member | 21, 22, or 31: process part |
| 30: blocking member | 40: base |
| 50: frame | 100: mirror assembly |
| 200: drive motor | 201: upper rotation shaft |
| 202: lower rotation shaft | CL: center line |
| L11 or L21: light transmission | L12 or L22: light reception |
| MC1 or MC2: first or second mirror channel | |
| VA1 or VA2: first or second vertical angle | |
| of view | |
| θ1 or θ2: angle | |

What is claimed is:

1. A light detection and ranging (LIDAR) having an inclined scanning mirror structure, the LIDAR comprising:
one mirror including a light transmitting part and a light receiving part integrated into it, the light transmitting part reflecting and transmitting laser light radiated thereto, and the light receiving part receiving the laser light reflected from an object after the light transmission;
a mirror installation member rotated with the mirror installed thereon; and
a blocking member installed at the mirror installation member, and dividing the mirror into the light transmitting part and the light receiving part.

2. The LIDAR of claim 1, wherein
the mirror is inclined at a set angle in an up-down direction.

3. The LIDAR of claim 2, wherein
the blocking member is installed vertically relative to the up-down direction at the mirror.

4. The LIDAR of claim 1, wherein
the mirror installation member is a plate, and
the mirror is installed on one surface of the plate.

5. The LIDAR of claim 1, wherein
at least one of the mirror installation member and the blocking member has a process part for preventing vibration during its rotation.

6. A light detection and ranging (LIDAR) having an inclined scanning mirror structure, the LIDAR comprising:
one pair of mirrors each including a light transmitting part and a light receiving part, the light transmitting part reflecting and transmitting laser light radiated thereto, and the light receiving part receiving the laser light reflected from an object after the light transmission; and
a mirror installation member rotated with the one pair of mirrors installed thereon, facing each other at an angle of 180 degrees,
wherein the one pair of mirrors is
inclined at set angles different in an up-down direction.

7. The LIDAR of claim 6, wherein
each of the one pair of mirrors includes the light transmitting part and the light receiving part integrated into it.

8. The LIDAR of claim 7, further comprising
a blocking member installed at the mirror installation member, and dividing each of the one pair of mirrors into the light transmitting part and the light receiving part.

9. The LIDAR of claim 7, wherein
the mirror installation member is a plate, and
the one pair of mirrors is installed on both surfaces of the plate to face each other at an angle of 180 degrees.

10. The LIDAR of claim 9, wherein
at least one of the mirror installation member and the blocking member has a process part for preventing vibration during its rotation.
